(19) United States
(12) Patent Application Publication
(10) Pub. No.: US 2013/0247149 A1
(43) Pub. Date: Sep. 19, 2013

(54) Internet protocol address authentication method

(71) Applicants: Theodore SANFT, Franklin, TN (US); Rathan IRUDIASAMI, Smyrna, TN (US); Samuel POOLE, Hermitage, TN (US)

(72) Inventors: Theodore SANFT, Franklin, TN (US); Rathan IRUDIASAMI, Smyrna, TN (US); Samuel POOLE, Hermitage, TN (US)

(21) Appl. No.: 13/421,397

(22) Filed: Mar. 15, 2012

(51) Int. Cl. G06F 21/00

(52) U.S. Cl. 726/4

(57) ABSTRACT

A method for secure authentication is provided which includes having a user who wishes to gain access to a computer or computer network have the IP address associated with the device to which the user wishes to gain access be in a whitelist of IP addresses associated with the user computer account. If the IP address is not associated initially with the user's computer account, the user is presented with a contact address, e.g., a telephone number, which a user uses to be presented with secondary authentication questions. Upon the user answering the secondary authentication question(s) correctly, the IP address of the user is added to the whitelist of IP addresses associated with the user's computer account and the user is provided access to the user account.

### FIELD OF THE INVENTION

The present invention relates to an authentication method and, in particular, an authentication method which uses secondary authentication based on an Internet protocol (IP) address of a device of a user wishing access to a computer system or network.

### BACKGROUND OF THE INVENTION

Limiting access to a computer, computer network or computer system is often a high priority. The limited access may be to an entire computer network or server, or the limited access may be to just specific functions or portions of a computer network or server. Several systems have been developed which limit access by using passwords separately or in combination with a username, biometrics and/or responses to queries posed to a user desiring computer access.

Increasingly, users seeking access to a computer system or network often do so using public computers, such as computers not controlled by the owner of a computer network or computer system to which a user wishes access. Such computers include computers at hotels, libraries, individual homes and schools, just to name a few. In addition, often a user accesses a computer network by using a public entry point, such as a public Wi-Fi hot spot, home computer network, an Internet Service Provider (“ISP”), wireless broadband carrier, or other wireless or hardwired router other than that of the computer system to which the user ultimately wishes to gain access.

One security issue which arises with a user accessing a computer network using a public computer or entry point is that the public computer or entry point is not necessarily secure, i.e. one can either intercept a transmission as a user gains access to the computer network or the public computer or public access point may retain authentication data of the user as he or she authenticates access to the computer network. One potential security issue is that unauthorized access may be obtained by using data which is intercepted as the authorized user accesses the computer network or by using authentication information which has previously been stored on the computer or intermediate router or server as the authorized user gains access to the computer network.

An additional security issue arises from spyware which can record conventional username and password entries as an authorized user accesses a computer network. For example, spyware can track and store keystrokes as an authorized user uses a non-secure computer and then relay the recorded information to allow unauthorized access to the computer network. Yet another security issue arises when an unauthorized person or camera observes an authorized user's entry of a username and password while in public.

What is needed in the art is a method and system which provides an additional layer of security over conventional username and password authentication.

### SUMMARY OF THE INVENTION

The present invention relates to a method and system for secure authentication, in which a user gains access to a computer, computer system or network or to specific functions of a computer network, only if the IP address of the device of the user has been preauthorized for that particular user, i.e. associated with the user's account. Preapproved IP addresses associated with the user account are stored in what is referred to in the art as a whitelist of IP addresses. The IP addresses in the whitelist may be ones which have been preapproved at the time a user account is created, e.g., IP addresses associated with an employer, the private residence of a user, and the like. Alternatively, or in addition, new IP addresses can be added to the whitelist after the user has successfully answered secondary authentication questions.

If the IP address of a device which a user is using to gain access to a computer or network is not in the IP address whitelist, the user is presented with a contact address associated with the owner or operator of the computer system or network. The contact address may be a telephone number or URL. The user is invited to use the contact address (e.g., telephone number or URL) to contact the owner or operator of the computer and/or network.

Using the contact address, the user is then presented with secondary authentication questions which previously have been presented to the user or ones he or she should know and for which responses have been associated with the user's account. Upon the user correctly answering the questions presented to the user, the IP address of the user is added to the IP address whitelist associated with the user's account and the user is provided with access to the computer or network account.

The secure authentication method can be further enhanced by including a username and password associated with a user account. In order to gain access, the user will first be prompted to enter his or her username or login ID, followed by a password. If the IP address of the user's device is in the IP address whitelist associated with the user's account, the user is allowed access to the computer or network. If the IP address of the user's device is not already in the IP address whitelist associated with the user's account, the user is presented with the contact address or telephone number for the user to use in order to contact the owner or operator associated with the computer system or network. The user will then be presented with secondary authentication questions which must be answered correctly in order to gain access to the computer system or network.

The present invention, in one form, relates to a method for secure authentication. The method includes allowing a user to access a computer, computer system, server or computer network (collectively referred to as a “computer”) via a user interface. An IP address for the user interface is determined and the IP address is compared with IP addresses in the IP address database associated with a user account. The user account includes account information, such as username and IP address database. If the IP address is in the database of IP addresses associated with the user account, the user interface is authorized and the user is authenticated as an authorized user. If the IP address is not in the IP address database associated with the user account, the method further includes presenting the user with a telephone number or other contact address associated with the owner or operator of the computer. The method further includes receiving a call or contact from the user using the telephone number or contact address for the owner or operator of the computer. The user is presented with at least one secondary authentication question and the method receives a response to the at least one secondary authentication question from the user via the telephone or contact address. The user is authenticated as an authorized user if the user correctly answers the at least one secondary authentication question.

In one specific, further form, the method includes creating a user account and presenting a user with at least one secondary authentication question and receiving a response to the at least one secondary authentication question and associating the response of the at least one secondary authentication question with the user account.

### BRIEF DESCRIPTION OF THE DRAWING

The invention will be explained in more detail below, with reference to particular preferred embodiments, as well as the drawings in which:

FIG. 1 is a schematic showing a computer system for implementing the present authentication method.

FIG. 2 depicts a user interface screen used during authentication, in accordance with the present method.

FIG. 3 is a flowchart, in accordance with one aspect of a secure authentication method, in accordance with the present invention.

FIG. 4 is flowchart, in accordance with another method for secure authentication, in accordance with the present invention.

FIG. 5 is a flowchart, in accordance with another method for secure authentication, in accordance with the present invention.

Other embodiments and features of the present invention will become apparent from the following detailed description considered in conjunction with the accompanying drawings. It is to be understood, however, that the drawings are designed as an illustration only and not as a definition of the limits of the invention.

### DETAILED DESCRIPTION

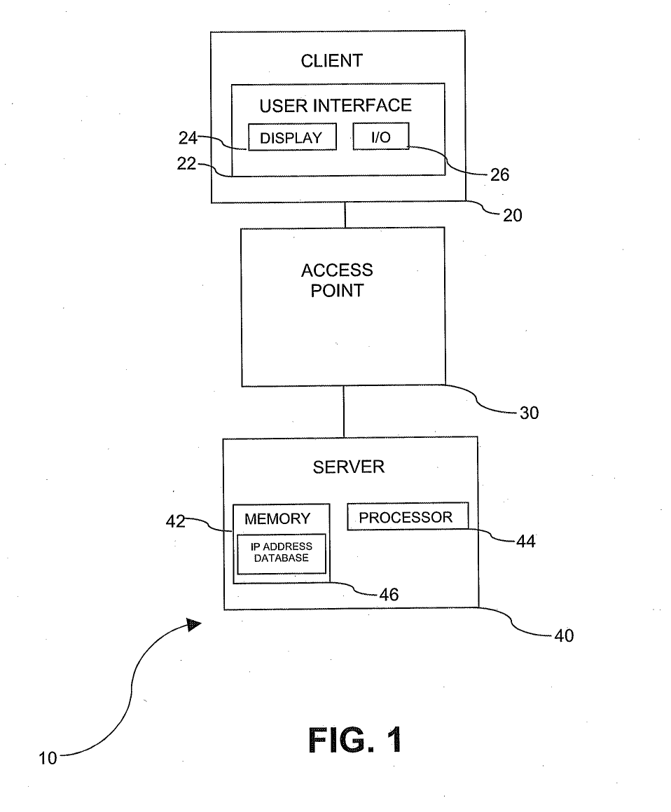

The present invention will now be described with reference to the figures. Referring specifically to FIG. 1, computer system 10 includes a client computer, an access point 30 and a server 40. The client computer 20 can be any computer which includes, but is not limited to, a personal computer, PDA, Smartphone, tablet computer, etc. The client computer 20 has a user interface 22 which includes a display 24 and an input/output device 26. The input/output device 26 can be any appropriate input/output device which is appropriate which includes, but is not limited to, a touch screen, a trackball and mouse. The user interface 22 is used for authentication and access to the server 40 through the access point 30.

The access point 30 can be a public access point, such as a Wi-Fi hot spot, home network connected to the Internet or other computer network, a wireless Internet Service Provider (“ISP”) or cell phone carrier.

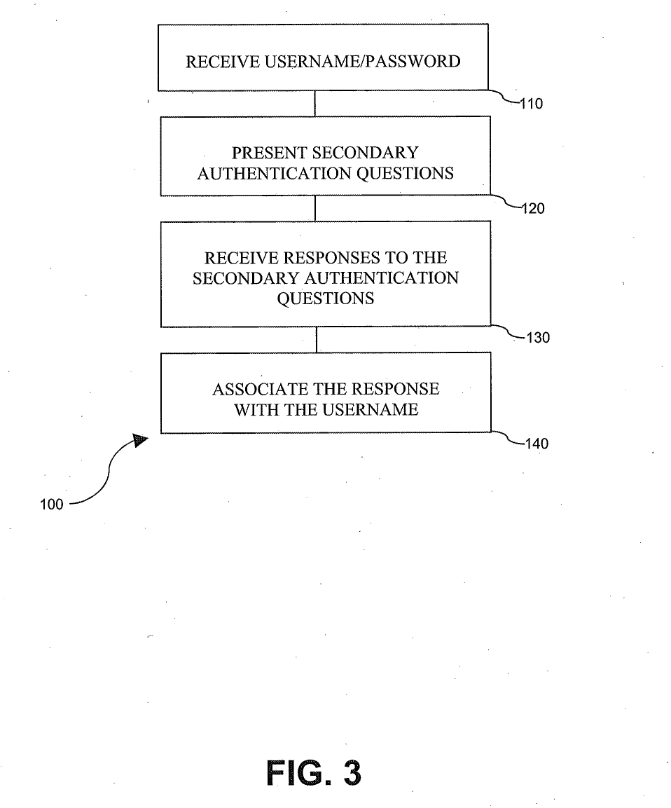

Referring to FIGS. 1 and 3, a pre-authentication or an enrollment method 100 is used by a user to initially set up his or her computer account on server 40. A user, using interface 24, logs in to server 40 by entering his or her username or login ID and password for his or her user account which was previously created in memory 42 (step 110). Next, the user is presented with one or more secondary authentication questions. Advantageously, the user is presented with several secondary authentication questions, which may include one to ten or more (step 120). For example, a user may be presented with questions: street which you grew up on, favorite color, first pet name, first niece's name, etc. (step 120). The user, via input/output device 26, enters the correct responses to the questions presented to the user (step 130). The responses of the user are associated with the user account (step 140). For example, the server 40 stores the user responses in memory 42 on server 40 (step 140).

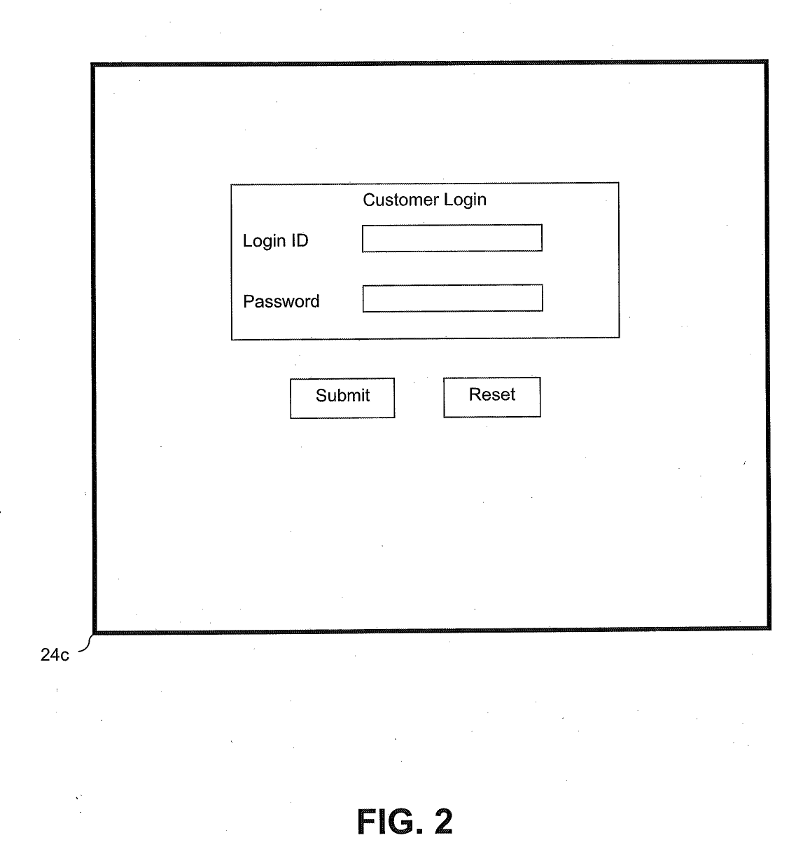

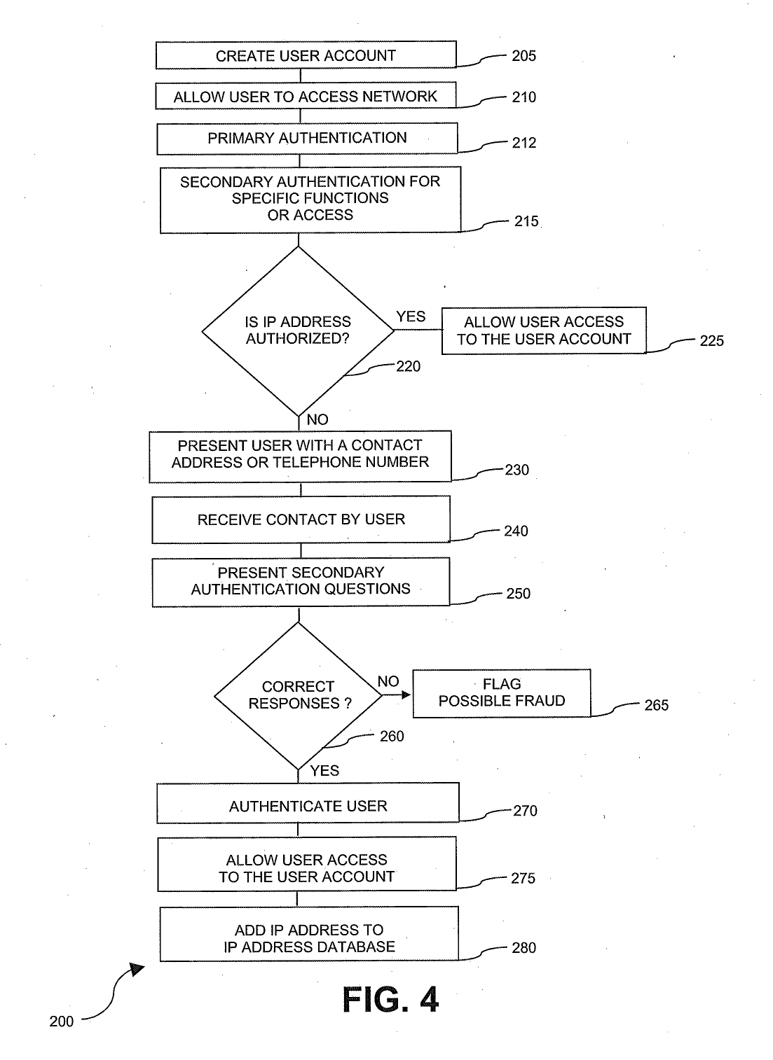

Referring to FIG. 2 and the flowchart of FIG. 4, along with FIG. 1, method 200 authenticates a user for access to the server 40. After the user account has been created on server 40 in memory 42 using processor 44 (step 205), such as via method 100 (FIG. 3), a user wishing to gain access to server 40 uses the client computer 20 through access point 30 to request access to server 40 (step 210). The user is first prompted to enter his or her username and password via interface 22 during a primary authentication procedure (step 212), as shown in display 24c of FIG. 2.

If the username and password are correct, the user may be given access to certain portions of the server 40. As necessary or desired, prior to gaining access to certain content and functions of the server 40, secondary authentication may be required (steps 215-280). For example, a user may wish to gain access to functions which are further restricted, requiring the secondary authentication, such as the user entering a secondary ID and password or security code (step 215).

Server 40 then determines if an IP address associated with the access point 30 corresponds to an IP address which has previously been identified as an approved access point associated with the user account (step 220). For example, approved access points or IP addresses may include IP addresses internal to a company which hosts or owns server 40, private home IP addresses, IP addresses of a particular vendor, etc. The approved IP addresses are stored in memory 42 in an IP address whitelist database 46. The IP address can be added to the user account in an IP whitelist database by the owner or operator associated with the server 40 when the user account is created. Alternatively, or in addition, IP addresses are added to the IP address whitelist database 46 associated with the user account upon authentication, as will be discussed below (step 280).

Upon a user seeking access to server 40, the processor 44 identifies the IP address of access point 30 and compares that IP address with approved IP addresses in the IP address whitelist database 46 associated with the user account (step 220). If it is a preapproved or authorized IP address, the user is allowed access to the user account on server 40 (step 225).

If the IP address access point 30 is not a preapproved IP address associated with the user account (step 220), the user will be presented with a contact address or telephone number on the user interface 22, e.g., display 24 (step 230). The user then contacts the owner or operator associated with server 40 using the contact address or telephone number which was presented to the user (step 240).

Via the contact address or telephone number, the user is then presented with the secondary authentication questions. The questions are ones which the user and the owner/operator of server 40 know, or ones which have previously been presented to the user, and his or her responses are associated with the user account in memory 42 (step 250). For example, a user may use his or her telephone to call the number which has been presented to the user on display 24. The user is then presented with one or more of the secondary authentication questions to which the user provides responses (step 260).

If the user correctly answers the questions presented, the user is authenticated (step 270) and subsequently allowed access to the user account (step 275). As a result, the user is given immediate access to the computer account (step 275). Finally, the server 40 adds the user's IP address to the IP address whitelist database associated with the user account (step 280). If the user answers incorrectly (step 260), the owner/operator is alerted to a possible fraud attempt (step 265) and the user is not allowed access.

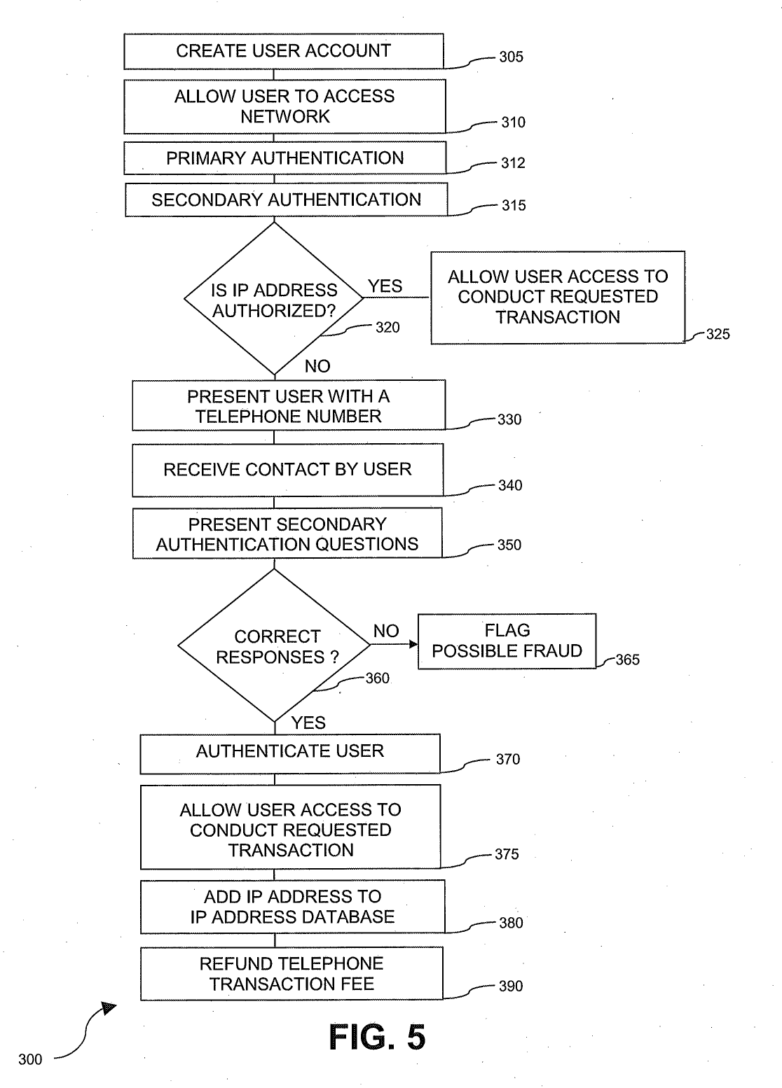

Referring now to the flowchart of FIG. 5, authentication method 300 exemplifies application of an authentication method applicable for financial transactions. Authentication method 300 can be implemented using computer system 10. A user wishing to gain access to his or her computer account (previously created at step 305, as described above with regard to step 205 and method 100) first uses the client computer 20 to request access to the server (step 310). The user enters his or her username and password (step 312) and, if correct, the user is allowed access to his or her user account and is provided access to certain functions. However, if a user wishes to gain access to his or her bank account or to conduct financial transactions, the user is prompted to enter a secondary authentication user identification (user ID) and a secondary password (step 315). For example, the user may be prompted to enter his or her employee ID and security code (step 315).

Server 40 then determines if an IP address associated with the access point 30 used by the user corresponds to an IP address which is associated with the user account (step 320). If the IP address is associated with the user account (step 320), the user is allowed access to financial functions and/or to conduct financial transactions as requested (step 325). As a result, the user can now conduct the financial transactions, which may include a wire transfer of money, issuance of a bank draft or cashier's check or other financial transaction.

If the IP address access point 30 is not a preapproved IP address associated with the user account (step 320), the user will be presented with a telephone number on the user interface 22, e.g., display 24 (step 330). The user then contacts the owner or operator using the telephone number (step 340), is presented with secondary authentication questions (step 350), and provides his or her responses to those questions (step 360). If the responses are correct (step 360), the user is authenticated (step 370) and the user is allowed to conduct financial transactions (step 375), as discussed above. In addition, the IP address is added to the IP address database associated with the user account (step 380). Further, a transaction fee, which is associated with contacting the owner/operator by telephone, is refunded to the user (step 390).

Alternatively, if the user answers the questions incorrectly (step 360), the telephone authentication fee will not be refunded, the owner/operator is alerted of a possible fraud attempt (step 365) and the user is not allowed to conduct the requested financial transactions.

The present secure authentication method provides advantages and features over prior authentication methods. Presenting a user with a contact address or telephone number, if a user's IP address is not in a whitelist associated with the user account, provides an additional layer of security to computer networks and computer systems. Only devices attempting to gain access to the computer system using approved IP addresses associated with the user account are allowed access or a user must correctly answer secondary authentication questions. As a result, spyware cannot merely record keystrokes associated with a user account and password unless the unauthorized access is using the same device or IP address in the whitelist of IP addresses associated with the user account. Further, having a user contact the owner or operator of a computer network or server via a telephone number or contact address, other than the one which the user has been using to enter username and password, provides an additional layer of security. While one may be inclined to answer secondary authentication questions using the same user interface and display which is being used to enter a username and password, an unauthorized user may be less inclined to contact a server using a telephone number and/or additional different contact address, thereby providing additional security over prior authentication methods.

Although the invention has been described above in relation to preferred embodiments thereof, it will be understood by those skilled in the art that variations and modifications can be effected in these preferred embodiments without departing from the scope and spirit of the invention.

1. A method for secure authentication, said method comprising:
(a) allowing a user to access a computer via a user interface;
(b) determining an IP address for the user interface;
(c) comparing the IP address with IP addresses in the IP address database associated with a user account, comprising account information including a username and an IP address database.
wherein,
if the IP address is in the IP address database associated with the user account,
(d) identifying the user interface as an authorized IP address and
(e) authenticating the user as an authorized user; and
if the IP address is not in the IP address database associated with the user account, the method further comprises:
(f) presenting the user with a telephone number;
(g) receiving a call from the user, using the telephone number;
(h) presenting the user with at least one secondary authentication question;
(i) receiving a response from the user, via the telephone in response to the at least one secondary authentication question; and
(j) authenticating the user as an authorized user if the user correctly answers the at least one secondary authentication question.

2. The method of claim 1, further comprising creating a user account.

3. The method of claim 2, wherein the creating a user account comprises:
presenting the user with at least one secondary authentication question;
receiving a response to the at least one secondary authentication question;
associating the response to the at least one secondary authentication question with the user account.

4. The method of claim 1, wherein the user with at least one secondary authentication questions comprises presenting at least two secondary authentication questions and wherein receiving a response comprises receiving a response for each question.

5. The method of claim 1, further comprising receiving a username and password from the user via the computer user interface prior to presenting the user with the plurality of images, and wherein the account information includes the user password.

6. The method of claim 1, wherein authenticating the user allows the user to have access to a server via a computer network accessible via the user interface.

7. The method of claim 1, wherein the user account further comprises at least one secondary authentication response and wherein authenticating the user comprises authorizing the user if the user correctly answers the at least one secondary authentication question based on the at least one secondary authentication response associated with the user account.

8. The method of claim 1, wherein (b) determining an IP address and (c) comparing the IP address are only performed in response to the user requesting access to specifically restricted information or a restricted function.

9. The method of claim 8, wherein, prior to (b) determining the IP address, the method further comprises receiving a secondary user identification and a secondary password associated with the second user identification.

10. The method of claim 9, wherein the secondary user information is an employee ID and the secondary password is a security code.

11. A method for secure authentication, said method comprising:
(a) allowing a user to access a computer via a user interface;
(b) determining an IP address for the user interface;
(c) comparing the IP address with IP addresses in the IP address database associated with a user account, wherein the user account comprises account information including a username and an IP address database;
wherein,
if the IP address is in the IP address database associated with the user account,
(d) identifying the user interface as an authorized IP address and
(e) authenticating the user as an authorized user; and
if the IP address is not in the IP address database associated with the user account, the method further comprises:
(f) presenting the user with a contact address associated with a host of the user account, the contact address being different from an address used to allow the user access to the computer;
(g) receiving contact from the user, using the contact address;
(h) presenting the user with at least one secondary authentication question via the contact address;
(i) receiving a response from the user, via the contact address in response to the at least one secondary authentication question; and
(j) authenticating the user as an authorized user if the user correctly answers the at least one secondary authentication question.

12. The method of claim 11, wherein the contact address is a telephone number associated with the host.

13. The method of claim 11, wherein the user account further comprises at least one secondary authentication response and wherein authenticating the user comprises authorizing the user if the user correctly answers the at least one secondary authentication question based on the at least one secondary authentication response associated with the user account.

14. The method of claim 11, wherein (b) determining an IP address and (c) comparing the IP address are only performed in response to the user requesting access to specifically restricted information or a restricted function.

15. The method of claim 14, wherein, prior to (b) determining the IP address, the method further comprises receiving a secondary user identification and a secondary password associated with the second user identification.

16. The method of claim 15, wherein the secondary user information is an employee ID and the secondary password is a security code.

17. A system having secure authentication, said system comprising:
a computer user interface;
computer memory; and
a computer processor adapted for executing computer instruction, said instruction comprising:
(a) allowing a user to access a computer via a user interface;
(b) determining an IP address for the user interface;
(c) comparing the IP address with IP addresses in the IP address database associated with a user account in the computer memory, wherein the user account comprises account information including a username and an IP address database;
wherein,
if the IP address is in the IP address database associated with the user account, the processor executes instruction for:
(d) identifying the user interface as having an authorized IP address and
(e) authenticating the user as an authorized user; and
if the IP address is not in the IP address database associated with the user account, the processor executes instruction for:
(f) presenting the user with a telephone number;
(g) receiving a call from the user, using the telephone number;
(h) presenting the user with at least one secondary authentication question;
(i) receiving a response from the user, via the telephone in response to the at least one secondary authentication question; and
(j) authenticating the user as an authorized user if the user correctly answers the at least one secondary authentication question.

18. The system of claim 17, wherein the computer processor is a processor of a server and authenticating the user allows the user to have access to the server via the user interface.

19. The system of claim 17, wherein the user account further comprises at least one secondary authentication response and wherein authenticating the user comprises authorizing the user if the user correctly answers the at least one secondary authentication question based on the at least one secondary authentication response associated with the user account.

20. The system of claim 17, wherein (j) authenticating the user comprises adding the IP address of the user interface to the IP address database if the user correctly answers the at least one secondary authentication question.
